(19) United States
(12) Patent Application Publication
(10) Pub. No.: US 2024/0026227 A1
(43) Pub. Date: Jan. 25, 2024

(54) IMPROVED CONFIGURATION OF VACUUM DISTILLATION UNIT AND PROCESS FOR SEPARATING COMPONENTS OF REDUCED CRUDE OIL

(71) Applicant: Engineers India Limited, Haryana (IN)

(72) Inventors: Ashwani MALHOTRA, Delhi (IN); Ravi Kant GUPTA, Gurgaon (IN); Alka SHARMA, Gurgaon (IN); Ameya Krishna DHOK, Delhi (IN)

(73) Assignee: Engineers India Limited, Haryana (IN)

(21) Appl. No.: 18/109,959

(22) Filed: Feb. 15, 2023

(30) Foreign Application Priority Data
Jul. 18, 2022 (IN) 202211040905

(51) Int. Cl. C10G 7/06; B01D 3/10

(52) U.S. Cl. CPC C10G 7/06; B01D 3/105

(57) ABSTRACT

A vacuum distillation unit and process for separating components of reduced crude oil by operating the vacuum distillation unit. The process includes feeding reduced crude oil in a vacuum column by a feed line, supplying a stripping stream at a lower portion of the vacuum column by an ejector, receiving an overhead vapour stream by the ejector from an upper portion of the vacuum column, creating the stripping stream in the ejector by mixing the overhead vapour stream into a steam, and supplying part of the stripping stream at the lower portion by the ejector to re-circulate the overhead vapour stream from the upper portion to the lower portion of the vacuum column.

### TECHNICAL FIELD

The present disclosure relates to the field of crude oil distillation. Particularly, the present disclosure relates to a vacuum distillation unit and a process for separating components of reduced crude oil by operating the vacuum operating unit. Further, embodiments of the present disclosure relate to a vacuum distillation unit that is designed to reduce steam requirement in the process of separating components of reduced crude oil.

### BACKGROUND OF THE DISCLOSURE

The information in this section merely provides background information related to the present disclosure and may not constitute prior art(s) for the present disclosure.

In refineries, an atmospheric distillation unit and a vacuum distillation unit are commonly used for the distillation of crude oil. The atmospheric distillation unit is designed to separate components of the crude oil at atmospheric pressure and the vacuum distillation unit is designed to separate components of reduced crude oil at reduced pressure. The crude oil is first passed through the atmospheric distillation unit to separate hydrocarbons namely, fuel gases, Liquid Petroleum Gas (LPG), naptha, kerosene, diesel, fuel oil, etc. of the crude oil. During distillation of the crude oil, residual oil of the crude oil remains at bottom of a column of the atmospheric distillation unit. The remained residual oil is evacuated from the bottom of the column and further transferred to the vacuum distillation unit for distillation of the remained residual oil. The remained residual oil may be called reduced crude oil.

Conventionally, there are different kinds of vacuum distillation units used in refineries for distillation of the reduced crude oil, in which one kind of vacuum distillation unit is illustrated in FIG. 1. The conventional vacuum distillation unit includes a vacuum column (B1) and an ejector (B2). The vacuum column (B1) is fluidly connected to the ejector (B2) by a flow path (S2). The primary purpose of the ejector (B2) is to maintain a vacuum inside the vacuum column (B1) by drawing a stream from the vacuum column (B1) via the said flow path (S2). For distillation of the reduced crude oil, the vacuum distillation unit receives fresh steam from at least two different sources by following two or more different flow paths. For example a portion of the steam is received by the vacuum distillation unit by the ejector (B2) by following path ‘A’ and the other portion of the steam is received by the vacuum column (B1) from an external steam source (not shown) by following path ‘B’. Accordingly, there is a requirement to maintain at least two steam sources and at least two flow paths for feeding fresh steam into the vacuum column (B1), which is more energy-consuming and incurs high maintenance costs. Also, such a conventional vacuum distillation unit consumes only fresh steam in each cycle of the distillation of the reduced crude oil, thereby fresh steam consumption is high.

Further, the researchers have come up with modifications to the above-described vacuum distillation unit. The modified conventional distillation unit is illustrated in FIG. 2. The said vacuum distillation unit is designed to reduce fresh steam requirement by recycling the stream discharged from the overhead portion of the vacuum column (B3) to the vacuum column (B3). The stream discharged from the overhead portion of the vacuum column (B3) is recycled to a lower portion of the vacuum column (B3) by deploying an additional ejector (B5) with the vacuum column (B3) of the vacuum distillation unit. The additional ejector (B5) is connected to a stream flow path (S11) to receive the stream and the additional ejector (B5) is further connected to the lower portion of the vacuum column (B3) to supply a portion of the stream in the vacuum column (B3). Also, the additional ejector (B5) receives fresh steam (S9) from an external source and converts the low-pressurized stream discharged from the overhead portion of the vacuum column (B3) into a high-pressurized stream for recycling purposes. The problem associated with the said conventional vacuum distillation unit is that the unit requires more energy to drive the additional ejector (B5). Also, the initial and maintenance cost of an additional ejector (5) makes the distillation of the reduced crude oil, uneconomical, which is undesirable.

Patent Literature 1: U.S. Pat. No. 4,261,814. This patent literature is available on the official website of USPTO. The patent literature discloses a process to reduce energy during vacuum operation. The process includes recycling of gaseous mixture discharged from the upper portion of a vacuum column to a lower portion of the vacuum column and using the recycled stream as a stripping stream. During distillation of the reduced crude oil, a recycle gas stream ejector is additionally required to perform the process of recycling the stream from the upper portion of the vacuum to the lower portion of the vacuum column. The involvement of the additional ejector for recycling the stream increases energy requirement, which leads to the overall cost of distillation of reduced crude oil.

The present disclosure is directed to overcome one or more limitations stated above or any other limitations associated with the prior art.

### SUMMARY OF THE DISCLOSURE

The one or more shortcomings of the prior art are overcome by the system/assembly as claimed, and additional advantages are provided through the provision of the system/assembly/method as claimed in the present disclosure. Additional features and advantages are realized through the techniques of the present disclosure. Other embodiments and aspects of the disclosure are described in detail herein and are considered a part of the claimed disclosure.

In one non-limiting embodiment of the present disclosure, a process for separating components of reduced crude oil by operating a vacuum distillation unit is disclosed. The process comprises the steps of feeding reduced crude oil in a vacuum column by a feed line, supplying a stripping stream (mixture of hydrocarbon and steam) at a lower portion of the vacuum column by an ejector to pass through the reduced crude oil in the vacuum column, and receiving an overhead vapour stream by the ejector from an upper portion of the vacuum column after passing through the reduced crude oil in the vacuum column, creating the stripping stream in the ejector by mixing the overhead vapour stream received from the upper portion of the vacuum column into a steam received in the ejector from an external source and supplying a part of the stripping stream at the lower portion of the vacuum column by the ejector to re-circulate the overhead vapour stream from the upper portion of the vacuum column to the lower portion of the vacuum column.

In an embodiment of the present disclosure, the process comprising the step of creating vacuum inside the vacuum column by the ejector to lower the boiling point of the reduced crude oil in the vacuum column.

In an embodiment of the present disclosure, the overhead vapour stream is received by the ejector from the upper portion of the vacuum column through suction pressure created in a first path defined between the ejector and the upper portion of the vacuum column.

In an embodiment of the present disclosure, creating the stripping stream includes receiving the overhead vapour stream at a suction chamber of the ejector, mixing with the steam, and passing through a diffuser of the ejector to create the stripping stream.

In an embodiment of the present disclosure, the stripping stream is supplied from the ejector to the lower portion of the vacuum column through a second path defined between the ejector and the lower portion of the vacuum column.

In an embodiment of the present disclosure, the stripping stream is supplied from the ejector to a stripping zone defined at the lower portion of the vacuum column.

In an embodiment of the present disclosure, the stripping stream supplied to the stripping zone is a stripping medium.

In an embodiment of the present disclosure, the overhead vapour stream has pressure less than pressure of the steam.

In an embodiment of the present disclosure, the stripping stream at the lower portion of the vacuum column has pressure greater than pressure of the overhead vapour stream at the upper portion of the vacuum column.

In non-limiting embodiment of the present disclosure, a vacuum distillation unit for separating components of reduced crude oil is disclosed. The unit comprises a vacuum column that has a lower portion and an upper portion. The vacuum column comprises a stripping stream inlet formed at the lower portion and a stream outlet formed at the upper portion. Further, the unit comprises an ejector fluidly coupled to the vacuum column through a first path and a second path. The first path is defined between a suction chamber of the ejector and the stream outlet of the vacuum column to receive an overhead vapour stream in the suction chamber from the stream outlet, and the second path is defined between an outlet of the ejector and the stream inlet of the vacuum column to supply a part of stripping stream from the outlet to the stream inlet. Furthermore, said ejector is configured to create the stripping stream by mixing the overhead vapour stream received from the vacuum column into a steam received at an inlet of the ejector from an external steam source and supply the stripping stream to the stream inlet of the vacuum column for re-circulating the overhead vapour stream from the upper portion of the vacuum column to the lower portion of the vacuum column. Also, pressure of the stripping stream in the second path is greater than pressure of the overhead vapour stream in the first path.

It is to be understood that the aspects and embodiments of the disclosure described above may be used in any combination with each other. Several of the aspects and embodiments may be combined together to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristics of the disclosure are set forth in the description. The disclosure itself, however, as well as a preferred mode of use, further objectives, and advantages thereof, will best be understood by reference to the following description of an illustrative embodiment when read in conjunction with the accompanying drawings. One or more embodiments are now described, by way of example only, with reference to the accompanying drawings wherein like reference numerals represent like elements and in which:

FIG. 1 illustrates a schematic view of a vacuum distillation unit known in the art.

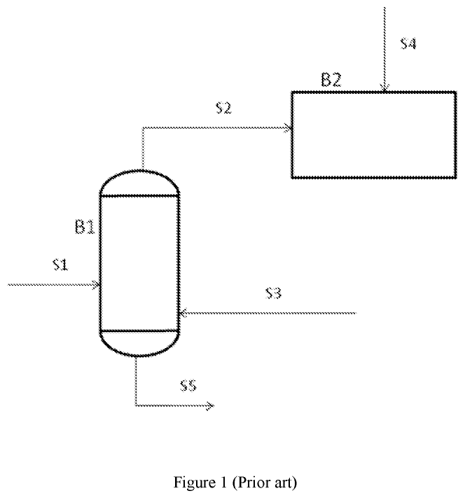

FIG. 2 illustrates another schematic view of another vacuum distillation unit known in the art.

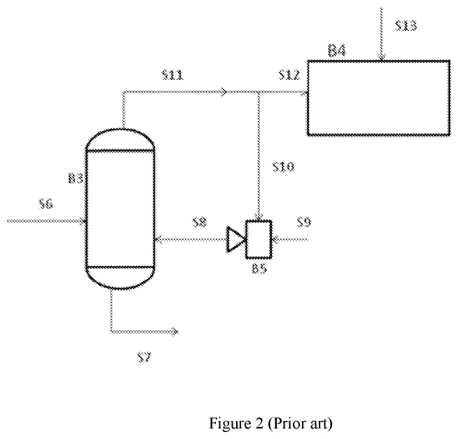

FIG. 3 illustrates a schematic view of a vacuum distillation unit, according to an embodiment of the present disclosure.

Skilled artisans will appreciate that elements in the drawings are illustrated for simplicity and have not necessarily been drawn to scale. For example, the dimensions of some of the elements in the drawings may be exaggerated relative to other elements to help improve understanding of embodiments of the present disclosure.

### DETAILED DESCRIPTION

While the disclosure is susceptible to various modifications and alternative forms, specific embodiments thereof have been shown by way of example in the Figures and are described in detail below. However, it should be understood that it is not intended to limit the disclosure to the particular forms disclosed. on the contrary, the disclosure is to cover all modifications, equivalents, and alternatives falling within the scope of the disclosure as defined by the appended claims.

Before describing detailed embodiments, it may be observed that the novelty and inventive step that are in accordance with the present disclosure resides in a vacuum distillation unit and a process for separating components of reduced crude oil by operating the vacuum distillation unit. It is to be noted that a person skilled in the art can be motivated from the present disclosure and modify the various constructions of the apparatus. However, such modification should be construed within the scope of the present disclosure. Accordingly, the drawings show only those specific details that are pertinent to understanding the embodiments of the present disclosure so as not to obscure the disclosure with details that will be readily apparent to those of ordinary skill in the art having the benefit of the description herein.

In the present disclosure, the term “exemplary” is used herein to mean “serving as an example, instance, or illustration.” Any embodiment or implementation of the present subject matter described herein as “exemplary” is not necessarily to be construed as preferred or advantageous over other embodiments.

The terms “comprises”, “comprising”, or any other variations thereof, are intended to cover non-exclusive inclusions, such that a device that comprises a list of components does not include only those components but may include other components not expressly listed or inherent to such setup or device. In other words, one or more elements in a system or apparatus proceeded by “comprises . . . ” does not, without more constraints, preclude the existence of other elements or additional elements in the system or apparatus.

The terms like “at least one” and “one or more” may be used interchangeably or in combination throughout the description.

Embodiments of the present disclosure disclose a vacuum distillation unit and a process for separating components of reduced crude oil by operating the vacuum distillation unit that ensures a reduction in fresh steam requirement and energy consumption for distillation of the reduced crude oil. Conventionally, the vacuum distillation unit includes a vacuum column and an ejector to maintain the vacuum inside the vacuum column. The vacuum column of the conventional distillation unit receives fresh steam from two or more different sources by following two or more separate flow paths. The involvement of such steam sources and flow paths consumes more energy and requires high maintenance. Also, the unit consumes fresh steam in each cycle of distillation of the reduced crude oil, which leads to fresh steam consumption. In some cases, the conventional distillation unit includes an additional ejector to recycle the stream discharged from the overhead portion of the vacuum column to the vacuum column, however, the involvement of the additional ejector, increases steam requirement and affects the overall cost of the distillation of the reduced crude oil.

Accordingly, the present disclosure discloses a vacuum distillation unit and a process for separating components of reduced crude oil by operating the vacuum distillation unit. The vacuum distillation unit ensures a reduction in steam requirement by recycling the part of the stream discharged from an overhead portion of the vacuum column to a lower portion of the vacuum column, without using any additional device/ejector. The unit comprises a vacuum column that has a lower portion and an upper portion. The vacuum column comprises a stream inlet formed at the lower portion and a stream outlet formed at the upper portion. Further, the unit comprises an ejector fluidly coupled to the vacuum column through a first path and a second path. The first path is defined between a suction chamber of the ejector and the stream outlet of the vacuum column to receive an overhead vapour stream in the suction chamber from the stream outlet, and the second path is defined between an outlet of the ejector and the stream inlet of the vacuum column to supply a part of stripping stream from the outlet of the ejector to the stream inlet. Furthermore, said ejector is configured to create the stripping stream by mixing the overhead vapour stream received from the vacuum column into steam received at an inlet of the ejector from an external steam source and supplying the stripping stream to the stream inlet of the vacuum column for re-circulating the part of overhead vapour stream from the stream outlet of the vacuum column to the stream inlet of the vacuum column. Also, the pressure of the stripping stream in the second path is greater than the pressure of the overhead vapour stream in the first path. The above-explained unit ensures a reduction in fresh steam requirement and energy consumption for the distillation of the reduced crude oil. Further, the above unit makes the operation of separating components of the reduced crude oil, economical. Also, the above unit leads to a reduction in carbon emissions.

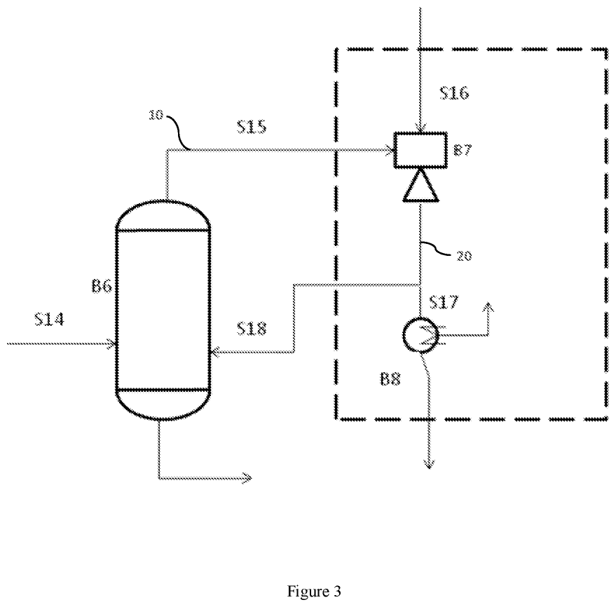

Reference will now be made to the exemplary embodiments of the disclosure, as illustrated in the accompanying drawings. Wherever possible, the same numerals will be used to refer to the same or like parts. Embodiments of the disclosure are described in the following paragraphs with reference to FIG. 3. In FIG. 3, the same element or elements which have the same functions are indicated by the same reference signs.

A vacuum distillation unit, according to an embodiment of the present disclosure, is depicted. The vacuum distillation unit (hereinafter, alternatively referred to as the “unit”) is a secondary processing unit that is capable to separate components of reduced crude oil. The vacuum distillation unit receives the reduced crude oil from an atmospheric distillation unit. The atmospheric distillation unit is a primary distillation unit where distillation of crude oil is performed. During distillation of the crude oil, the components such as gases, Liquefied Petroleum Gas (LPG), naphtha, kerosene, diesel, and reduced crude oil are separated. The distillation of the crude oil is performed based on their boiling temperature at atmospheric pressure.

Further, during the distillation of the crude oil, the residual oil remains at bottom surface of a atmospheric column of the atmospheric distillation unit. The said residual oil may be called reduced crude oil. The said reduced crude oil contains a high boiling temperature, therefore the reduced crude oil is evacuated from the bottom surface of the atmospheric distillation unit and transferred to the vacuum distillation unit for further distillation.

Referring to FIG. 3, the vacuum distillation unit comprises a vacuum column (B6). The vacuum column (B6) may have the shape of a cylindrical vessel. The vacuum column (B6) may be oriented at an upright position. The vacuum column (B6) is configured to receive the reduced crude oil from the atmospheric distillation unit via a feed line (S14) through a heater. The feed line (S14) is extended between the atmospheric distillation unit and the vacuum distillation unit through the heater. The feed line (S14) has an end that is disposed at the vacuum column (B6) at a pre-defined height. The pre-defined height may be extended from the bottom of the vacuum column (B6). Further, the end of the feed line (S14) may be disposed above from a stripping zone of the vacuum column (B6), without limiting the scope of the present invention. The “stripping zone” is referred to as a portion of the vacuum column (B6) where a stripping medium is injected inside the vacuum column (B6) to strip the reduced crude oil for distillation of the reduced crude oil. The “stripping medium” is referred to as a fresh steam/stream having high pressure configured to pass through the reduced crude oil in the vacuum column (B6).

The vacuum column (B6) includes a stream inlet and a stream outlet. The stream inlet is formed at a lower portion of the vacuum column (B6) and the stream outlet is formed at an upper portion of the vacuum column (B6). The stream inlet may be formed at the stripping zone that is defined at the lower portion of the vacuum column (B6)

The vacuum distillation unit comprises an ejector (B7). The ejector (B7) is configured to maintain a vacuum in the vacuum column (B6) for the distillation of reduced crude oil. As elucidated in the above paragraphs, the reduced crude oil has a high boiling point and the distillation of the reduced crude oil is performed based on its boiling point. Thus, to lower the boiling point of the reduced crude oil, the ejector (B7) is required to create a vacuum in the vacuum column (B6) of the vacuum distillation unit.

The ejector (B7) comprises a suction chamber, an inlet, a diffuser, and an outlet. The suction chamber is connected to the vacuum vessel to facilitate creating the vacuum in the vacuum column (B6). The inlet is configured to receive steam (S16) from an external steam source. The steam (S16) may be a motive fluid for the ejector (B7). The diffuser is configured to increase the pressure of the steam/stream that passes through the converging-diverging portion of the diffuser. The outlet is configured to allow the steam/stream to flow out from the diffuser towards outside the ejector (B7).

As shown in FIG. 3, the ejector (B7) is fluidly connected to the upper portion of the vacuum column (B6) through a first path (10). The first path (10) has one end that is connected to the stream outlet formed at the upper portion of the vacuum column (B6). The first path (10) has the other end that is connected to the suction chamber of the ejector (B7). The ejector (B7) creates the vacuum in the vacuum column (B6) by generating suction pressure in the first path (10)/vacuum column (B6). Upon generating suction pressure in the first path/vacuum column (B6), an overhead vapour stream is received from the stream outlet of the vacuum column (B6) at the suction chamber of the ejector (B7) through the first path (10).

As shown in FIG. 3, the ejector (B7) is further fluidly connected to the lower portion of the vacuum column (B6) through a second path (20). The second path (20) has one end that is connected to the stream inlet formed at the lower portion of the vacuum column (B6). The second path (20) has the other end that is connected to an outlet of the ejector (B7). The ejector (B7) supplies a stripping stream from the outlet of the ejector (B7) to the stream inlet by following the second path (20).

As shown in FIG. 3, the inlet of the ejector (B7) is fluidly connected to the external steam source to receive a steam (S16) from the external steam source. The steam (S16) is fresh steam that has high pressure. The steam (S16) is mixed with the overhead vapour stream (S15) and supplied to the lower portion of the vacuum column (B6) from the outlet of the ejector (B7) by passing through the diffuser. Once the distillation of the reduced crude oil starts, the stripping stream (S18) as a stripping medium is supplied to the stripping zone of the vacuum column (B6), in the first cycle of the distillation of the reduced crude oil. In further cycles of the distillation of the reduced crude oil, the stripping stream (S18) as stripping medium is supplied to the stripping zone of the vacuum column (B6).

The ejector (B7) is configured to create the stripping stream (S18). The stripping stream (S18) is created by mixing the overhead vapour stream (S15) received from the vacuum column (B6) into the steam (S16) received from the external steam source at the inlet of the ejector (B7). In the operation of creating the stripping stream (S18), the ejector (B7) creates suction pressure in the first path (10), thereby the ejector (B7) receives the overhead vapour stream (S15) from the stream outlet of the vacuum column (B6) at the suction chamber of the ejector (B7). Further, the overhead vapour stream (S15) is mixed with the steam (S16) in the diffuser of the ejector (B7). The part of the mixture of the steam (S16) and the overhead vapour stream (S15) is referred to as the stripping stream (S18).

The ejector (B7) supplies a part of the stripping stream (S18) to the stripping zone (S18) as the stripping medium for re-circulating the overhead vapour stream (S15) from the stream outlet of the vacuum column (B6) to the stream inlet of the vacuum column (B6). The re-circulation of the overhead vapour stream (S15) into the stripping zone ensures a reduction in the requirement of the steam. The pressure of the stripping stream (S18) is greater than the pressure of the overhead vapour stream (S15), thus the stripping stream (S18) can be readily used as a stripping medium in the stripping zone of the vacuum column (B6). After recirculation of the part of the stripping stream (S18), the remaining part of the stripping stream may be transferred to a condensation unit (B8) through a flow path (S17) for condensing the remaining part of the stripping stream (S18) for other operations.

Further, the present disclosure relates to a process for separating components of the reduced crude oil by operating the above-explained vacuum distillation unit. The process of separating components of the reduced crude oil starts with feeding the reduced crude oil in the vacuum column (B6) by the feed line (S14) and creating the vacuum in the vacuum column (B6) by the ejector (B7) to lower the boiling point of the reduced crude oil in the vacuum column (B6). The ejector (B7) creates suction pressure in the first path (10) in order to create the vacuum in the vacuum column (B6).

After feeding the reduced crude oil and creating the vacuum in the vacuum column (B6), the mixture of steam (S16) and the overhead vapour stream (S15) as stripping medium is supplied by the ejector (B7) to the stripping zone formed at the lower portion of the vacuum column (B6) to pass through the reduced crude oil in the vacuum column (B6). The stripping stream (S18) received in the stripping zone is further moved towards the stream outlet formed at the upper portion of the vacuum column (B6) and passed through the reduced crude oil for stripping the reduced crude oil. The stripping stream (S18) strips light hydrocarbons from the reduced crude oil, while passing through the reduced crude oil and getting converted into the overhead vapour stream (S15). Consequently, the overhead vapour stream (S15) at the stream outlet of vacuum column (B6) has pressure less than pressure of the steam (S16).

Subsequently in the process, the overhead vapour stream (S15) is received by the ejector (B7) from the upper portion of the vacuum column (B6). The overhead vapour stream (S15) is received at the suction chamber of the ejector (B7) through suction pressure created in the first path (10). The primary purpose of the ejector (B7) is to convert the overhead vapour stream (S15) to be discharged and part into the stripping stream (S18) so that it can be re-circulated in the stripping zone as a stripping medium.

Further in the process, the stripping stream (S18) is created in the ejector (B7) by mixing the overhead vapour stream (S15) received at the suction chamber and with the steam (S16) received at the inlet of the ejector (B7). The overhead vapour stream (S15) and the steam (S16) are passed through the diffuser of the ejector (B7) and create the stripping stream (S18) has pressure greater than pressure of the overhead vapour stream (S15) so that the stripping stream (S18) can be re-circulated as stripping medium in the stripping zone of the vacuum column (B6).

Further in the process, the ejector (B7) supplies a part of the stripping stream (S18) to the stripping zone of the vacuum column (B6) to re-circulate the overhead vapour stream (S15) from the stream outlet formed at the upper portion of the vacuum column (B6) to the stream inlet formed at the lower portion of the vacuum column (B6). While re-circulation of the said part of the stripping stream (S18), there is remained some parts of the stripping stream (S18) that may be supplied to the condensation unit (B8) through the flow path (S17) for condensation of the remaining part of the stripping stream (S18) for other operations.

Accordingly, the vacuum distillation unit, as explained above, ensures a reduction in the requirement of the steam and eliminates the requirement of any additional device/ejector to re-circulate the overhead vapour stream (S15) from the stream outlet formed at the upper portion of the vacuum column (B6) to the stream inlet formed at the lower portion of the vacuum column (B6), thereby, the vacuum distillation unit ensures reduction in energy consumption. Thus, the above vacuum distillation unit makes the operations of separating components of the reduced crude oil, simple and economical. Also, the above unit leads to a reduction in carbon footprint.

The various embodiments of the present disclosure have been described above with reference to the accompanying drawings. The present disclosure is not limited to the illustrated embodiments; rather, these embodiments are intended to fully and completely disclose the subject matter of the disclosure to those skilled in this art. In the drawings, like numbers refer to like elements throughout. The thicknesses and dimensions of some components may be exaggerated for clarity.

Herein, the terms “attached”, “connected”, “interconnected”, “contacting”, “mounted”, “coupled” and the like can mean either direct or indirect attachment or contact between elements, unless stated otherwise.

Well-known functions or constructions may not be described in detail for brevity and/or clarity. As used herein, the expression “and/or” includes any and all combinations of one or more of the associated listed items.

The terminology used herein is for the purpose of describing particular embodiments only and is not intended to be limiting of disclosure. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, operations, elements, and/or components but do not preclude the presence or addition of one or more other features, operations, elements, components, and/or groups thereof.

While considerable emphasis has been placed herein on the particular features of this disclosure, it will be appreciated that various modifications can be made and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

### LIST OF REFERENCE NUMERALS

| Sr. No. | Description |
|---|---|
| B6 | Vacuum Column |
| B7 | Ejector |
| B8 | Condensation unit |
| S14 | Feed line |
| S15 | Overhead vapour stream |
| S16 | Steam (motive steam) |
| S17 | Flow path |
| S18 | Stripping stream |
| 10 | First path |
| 20 | Second path |

### EQUIVALENTS

The embodiments herein and the various features and advantageous details thereof are explained with reference to the non-limiting embodiments in the description. Descriptions of well-known components and processing techniques are omitted so as to not unnecessarily obscure the embodiments herein. The examples used herein are intended merely to facilitate an understanding of ways in which the embodiments herein may be practiced and to further enable those skilled in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Any discussion of documents, acts, materials, devices, articles, and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations, and it is envisaged that the values higher/lower than the numerical values assigned to the parameters, dimensions or quantities fall within the scope of the disclosure unless there is a statement in the specification specific to the contrary.

1. A process for separating components of reduced crude oil by operating a vacuum distillation unit, the process comprising:
feeding reduced crude oil in a vacuum column by a feed line;
supplying a stripping stream at a lower portion of the vacuum column by an ejector to pass through the reduced crude oil in the vacuum column;
receiving an overhead vapour stream by the ejector from an upper portion of the vacuum column after passing through the reduced crude oil in the vacuum column;
creating the stripping stream in the ejector by mixing the overhead vapour stream received from the upper portion of the vacuum column into a steam; and
supplying a part of the stripping stream at the lower portion of the vacuum column by the ejector to re-circulate the overhead vapour stream from the upper portion of the vacuum column to the lower portion of the vacuum column.

2. The process as claimed in claim 1, comprising creating vacuum inside the vacuum column by the ejector to lower boiling point of the reduced crude oil in the vacuum column.

3. The process as claimed in claim 1, wherein the overhead vapour stream is received by the ejector from the upper portion of the vacuum column through suction pressure created in a first path defined between the ejector and the upper portion of the vacuum column.

4. The process as claimed in claim 1, wherein creating stripping stream includes receiving the overhead vapour stream at a suction chamber of the ejector, mixing with the steam, and passing through a diffuser of the ejector to create the stripping stream.

5. The process as claimed in claim 1, wherein said part of the stripping stream is supplied from the ejector to the lower portion of the vacuum column through a second path defined between the ejector and the lower portion of the vacuum column.

6. The process as claimed in claim 1, wherein said part of the stripping stream is supplied from the ejector to a stripping zone defined at the lower portion of the vacuum column.

7. The process as claimed in claim 6, wherein the stripping stream supplied to the stripping zone is a stripping medium.

8. The process as claimed in claim 1, wherein the overhead vapour stream has pressure less than pressure of the steam.

9. The process as claimed in claim 1, wherein the stripping stream at the lower portion of the vacuum column has pressure greater than pressure of the overhead vapour stream at the upper portion of the vacuum column.

10. A vacuum distillation unit for separating components of reduced crude oil, the unit comprising:
a vacuum column having a lower portion and an upper portion; the vacuum column comprises a stream inlet formed at the lower portion and a stream outlet formed at the upper portion;
an ejector fluidly coupled to the vacuum column through a first path and a second path, wherein the first path is defined between a suction chamber of the ejector and the stream outlet of the vacuum column to receive an overhead vapour stream in the suction chamber from the stream outlet, and the second path is defined between an outlet of the ejector and the stream inlet of the vacuum column to supply a part of a stripping stream from the outlet of the ejector to the stream inlet,
wherein said ejector is configured to create the stripping stream by mixing the overhead vapour stream received from the vacuum column into a steam received at an inlet of the ejector from an external steam source and supply the stripping stream to the stream inlet of the vacuum column for re-circulating the overhead vapour stream from the stream outlet of the vacuum column to the stream inlet of the vacuum column, and
wherein pressure of the stripping stream in the second path is greater than pressure of the overhead vapour stream in the first path.
